(19) United States
(12) Patent Application Publication
(10) Pub. No.: US 2018/0021800 A1
(43) Pub. Date: Jan. 25, 2018

(54) PRESSURE WASHER ACCESSORY TRAY

(71) Applicant: Briggs & Stratton Corporation, Wauwatosa, WI (US)

(72) Inventor: Paul Janik, Saukville, WI (US)

(73) Assignee: Briggs & Stratton Corporation, Wauwatosa, WI (US)

(21) Appl. No.: 15/217,296

(22) Filed: Jul. 22, 2016

(51) Int. Cl. B05B 15/06; B08B 3/02; B05B 7/24

(52) U.S. Cl. CPC B05B 15/06; B05B 7/2464; B05B 15/061; B08B 3/026

(57) ABSTRACT

A pressure washer includes a mounting platform, a prime mover supported by the mounting platform, a pump driven by the prime mover, a frame configured to support the mounting platform, a handle extending upward from the mounting platform, a spray gun including a barrel, a handle, and a nozzle, and an accessory tray attached to the frame proximate the mounting platform, the accessory tray including a spray gun clip configured to hold the barrel and a spray gun receptacle configured to hold the nozzle.

### BACKGROUND

The present invention relates generally to the field of pressure washers.

The arrangement of the accessories on a pressure washer are typically arranged as shown in FIG. 1. FIG. 1 illustrates a pressure washer 10. Pressure washer 10 includes a base unit 12 with a frame 14 supporting a prime mover 16, such as an internal combustion engine or an electric motor, and a water pump 18. The pressure washer 10 further includes a spray gun 20 and a wand 25. In some embodiments, the pressure washer 10 is portable and includes wheels 24 and a handle 26. The pressure washer 10 includes a spray gun holder 27, a wand holder 29, and a billboard 55. As shown in FIG. 1, the spray gun holder 27 and the wand holder 29 are positioned proximate the top portion of the handle 26 and on and/or proximate the billboard 55. The billboard 55 includes a plurality of nozzles 13 attached on the billboard 55. Frequently, the spray gun holder 27 and wand holder 29 are separate pieces that attach separately to the frame 14.

### SUMMARY

One embodiment of the invention relates to a pressure washer. The pressure washer includes a mounting platform, a prime mover supported by the mounting platform, a pump driven by the prime mover, a frame configured to support the mounting platform, a handle extending upward from the mounting platform, a spray gun including a barrel, a handle, and a nozzle, and an accessory tray attached to the frame proximate the mounting platform, the accessory tray including a spray gun clip configured to hold the barrel, and a spray gun receptacle configured to hold the nozzle.

Another embodiment of the invention relates to an accessory tray configured for use with a pressure washer. The accessory tray includes a spray gun clip configured to hold a spray gun at a barrel of the spray gun, a spray gun receptacle configured to accept the spray gun at a connector of the spray gun, a spray wand clip configured to hold a spray wand at a conduit of the spray wand, a spray wand receptacle configured to hold the spray wand at a wand nozzle, and a chemical container holder configured to hold a chemical supply container, wherein the chemical container holder includes a top portion and a bottom portion.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a pressure washer in accordance with the prior art;

FIG. 2 is a rear perspective view of a pressure washer, according to an exemplary embodiment;

FIG. 3 is a rear perspective view of the pressure washer of FIG. 2, according to an exemplary embodiment;

FIG. 4 is a rear view of the pressure washer of FIG. 2, according to an exemplary embodiment;

FIG. 5 is a rear perspective view of the pressure washer of FIG. 2, according to an exemplary embodiment;

FIG. 5A is a rear perspective view of the pressure washer of FIG. 2, according to an exemplary embodiment;

FIG. 6 is a perspective view of a pressure washer tray, according to an exemplary embodiment;

FIG. 7 is a top view of the pressure washer tray of FIG. 6, according to an exemplary embodiment;

FIG. 8 is a rear view of the pressure washer tray of FIG. 6, according to an exemplary embodiment; and

FIG. 9 is a section view taken along line 9-9 of FIG. 8, according to an exemplary embodiment.

FIG. 10 is a section view taken along line 10-10 of FIG. 8, according to an exemplary embodiment.

FIG. 11 is a section view taken along line 11-11 of FIG. 8, according to an exemplary embodiment.

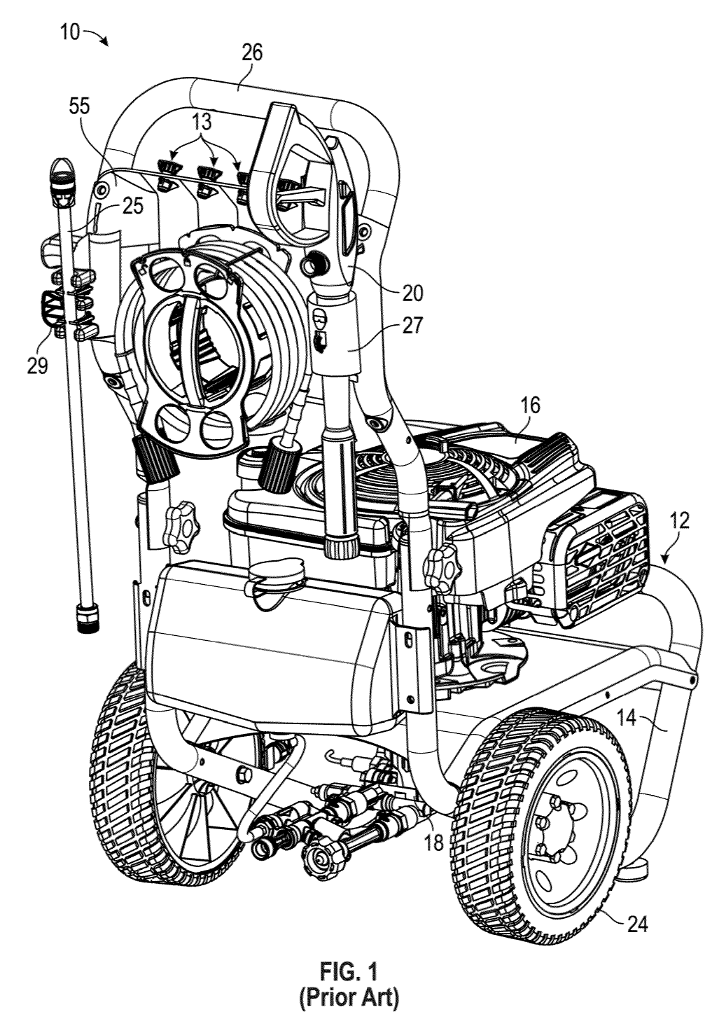

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

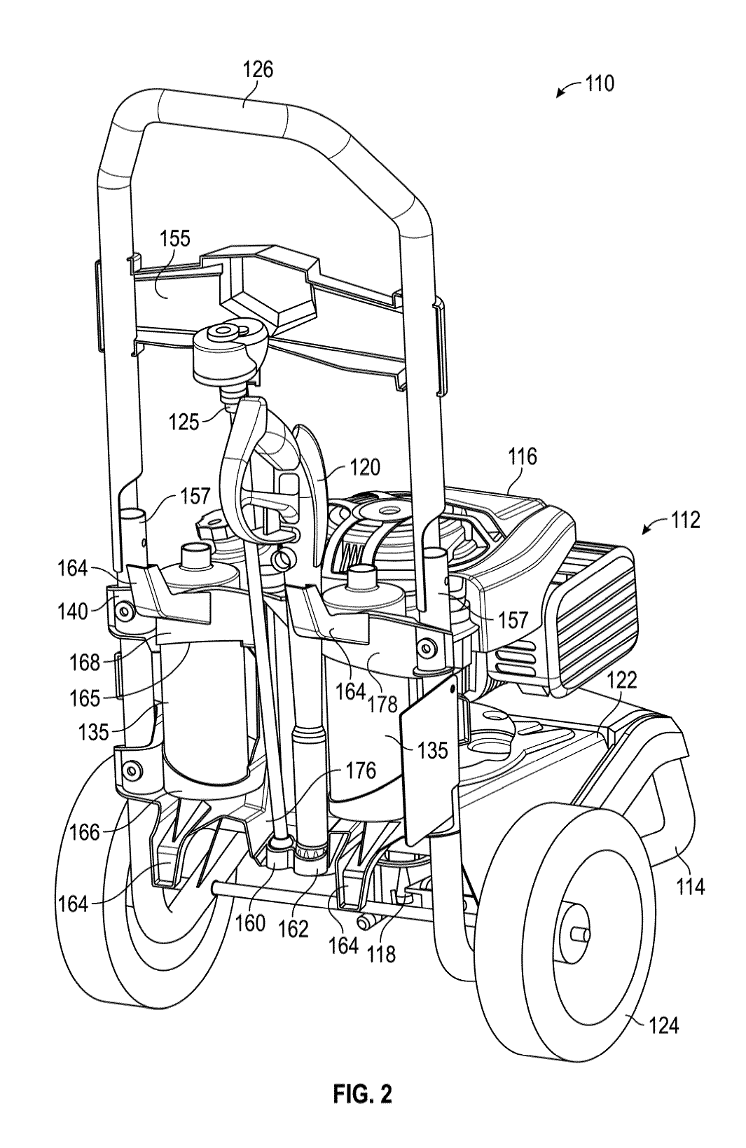

Referring to FIG. 2, a pressure washer 110 includes a base unit 112 with a frame 114 supporting a prime mover 116, such as an internal combustion engine or an electric motor, and a water pump 118 (e.g., positive displacement pump, piston water pump, axial cam pump). In some embodiments, the prime mover 116 is fastened to the top of a base plate 122 of the frame 114 and the water pump 118 is mounted below the base plate 122 and connected to a power takeoff of the prime mover 116 via a hole through the base plate 122. In other embodiments, the water pump 118 is directly coupled to and supported by the engine or prime mover 116. The water pump 118 is coupled (e.g., directly coupled, indirectly coupled by a transmission, belts, gears, or other drive system) to the prime mover 116 to be driven by the prime mover 116. In some embodiments, the pressure washer 110 is portable and includes wheels 124 and a handle 126. In other embodiments, the pressure washer 110 may be stationary. In other embodiments, the pressure washer 110 is mounted to a trailer or other vehicle.

The pressure washer 110 includes a billboard 155 and two legs 157. As shown in FIG. 2, the billboard 155 is positioned proximate the top portion of the handle 126 and is attached at two portions of the handle 126 extending downward from the top portion of the handle 126. The legs 157 are formed integral with the frame 114 and extend upward from the base plate 122 of the pressure washer 110 and attach to the handle 126. In one embodiment, the legs 157 are circular in cross-section. In another embodiment, the legs 157 can be rectangular in cross-section, or in alternative embodiments, the legs 127 can be any other shape.

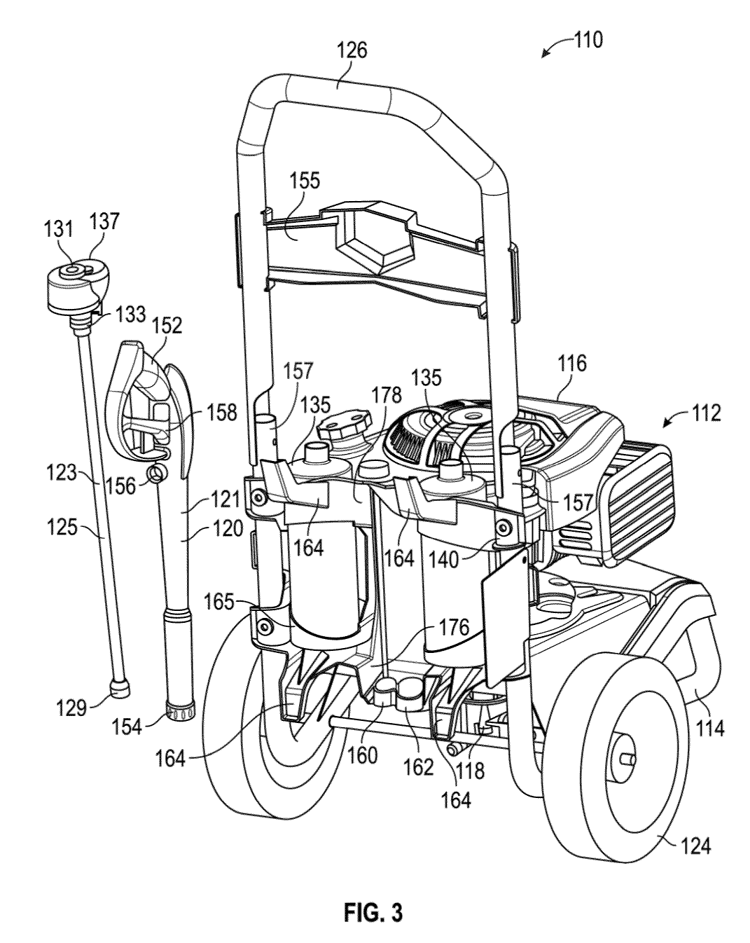

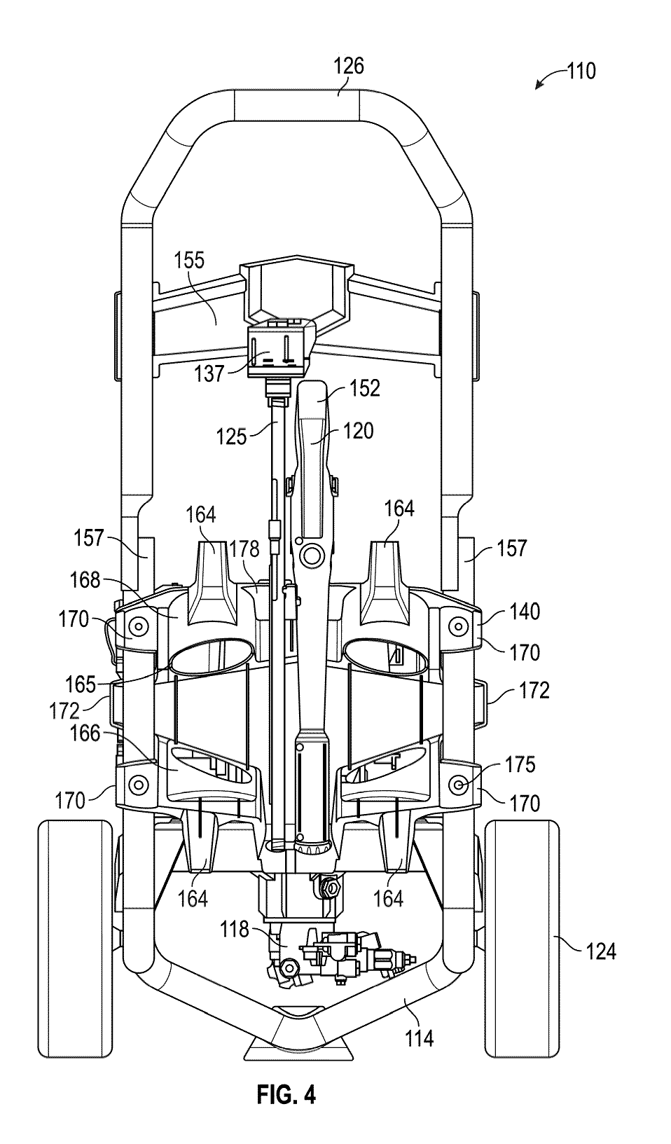

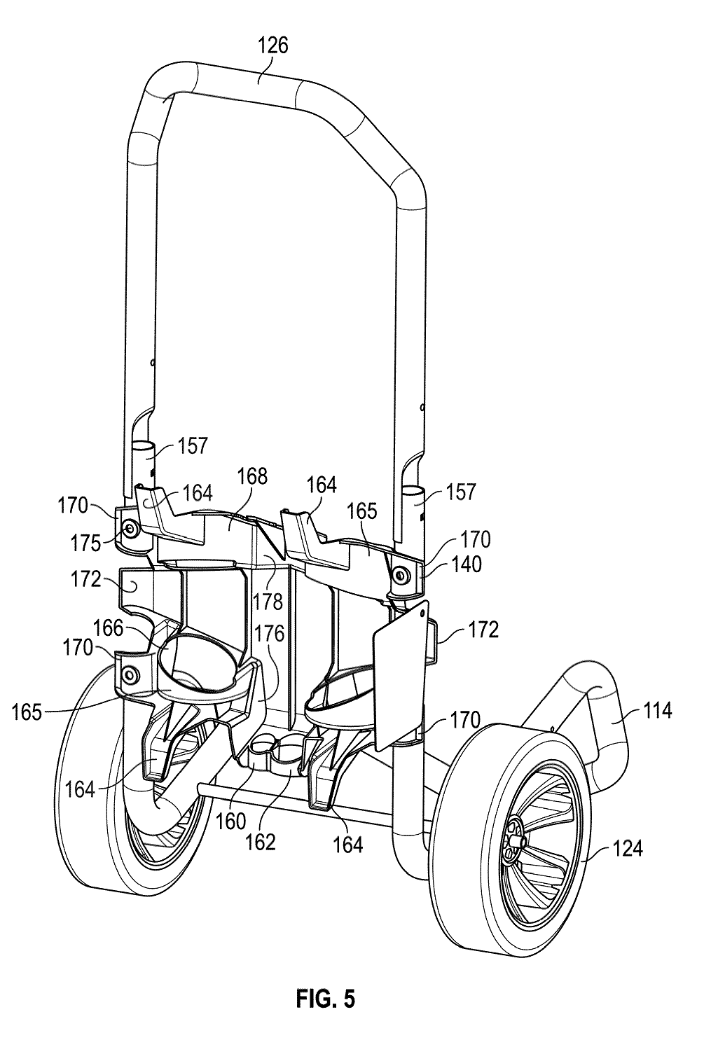

As shown in FIGS. 2-4, the pressure washer 110 includes a spray gun 120 that is configured to be coupled to the water pump 118 by a hose 150 (FIG. 5A). The spray gun 120 includes a spray gun barrel 121, a handle 152, and a nozzle 154. High pressure water is provided to the spray gun 120 from the outlet of the water pump 118 through a hose or delivery conduit, which is coupled to the spray gun 120 via an inlet 156. In one embodiment, the inlet 156 is a hose fitting, such as a high-pressure fitting (e.g., an M22 fitting). The stream of water output from the nozzle 154 can be started or stopped by a trigger 158. The spray gun 120 allows the user to manage the direction of the stream of water independent of the location and orientation of the base unit 112 and the duration of the stream of water. In some embodiments, the nozzle 154 is a variable nozzle that is capable of producing various patterns, pressures, and flow rates for the stream of water (e.g., the nozzle 154 may include a rotatable head with multiple openings). In some embodiments, the nozzle 154 receives one of multiple spray nozzles, each of which provide a different pattern, pressure, flow rate, etc. In some embodiments, the spray gun 120 is configured to be grasped with two hands, with one hand being placed on the handle 152 and a second hand being placed on a grip portion proximate the nozzle 154. The grasping of the spray gun 120 with two hands allows a user to have greater control of the stream of water expelled from the nozzle 154.

The pressure washer 110 further includes a spray wand 125. The spray wand 125 includes a connector 129 configured to attach a spray wand 125 to the spray gun 120. In some embodiments, spray wand 125 is omitted. In some embodiments, spray wand 125 is integral with the body of the spray gun 120 (i.e., body and spray wand are a single unity structure). At the opposite end of spray wand 125 is a nozzle connector 133 that couples a turret-style nozzle head 137 to wand 125. Nozzle connector 133 also may be any appropriate attachment means, i.e., threaded, quick-release, etc. In one embodiment, turret-style nozzle head 137 has a plurality of nozzles 131 from which pressurized fluid is ejected after traveling through the spray gun 120. In some embodiments, turret-style nozzle head 137 includes a plurality of spray nozzles 131 having differing diameters and shapes in order to adjust the pressure and spray pattern of the fluid ejected from gun 120. The turret-style nozzle head 137 may be rotated clockwise or counterclockwise to enable the user to select a desired nozzle. In other embodiments, multiple individually replaceable nozzles are provided in place of the rotatable nozzle head.

The pressure washer 110 further includes one or more chemical supply containers 135. The chemical supply containers 135 are configured to selectively introduce a liquid chemical into the water stream provided to the spray gun 120. The liquid chemical may be a detergent for cleaning various surfaces, a fertilizer for lawn care, a pesticide, an herbicide, etc. The chemical supply containers 135 are attached to the spray wand 125 and/or spray gun 120 via any appropriate attachment means, i.e. threading, quarter-turn, etc. In some embodiments, the chemical supply containers 135 are omitted.

As shown in FIGS. 2-5A, the pressure washer 110 further includes an accessory tray 140. The accessory tray 140 is configured to hold the spray gun 120, spray wand 125, the chemical supply containers 135, and a hose 150 (shown in FIG. 5A). The accessory tray 140 includes a top support 178 and a bottom support 176. The accessory tray 140 includes a base plate 171 with one or more ribs 179 extending along the height of the base plate 171 for further structural support of the accessory tray 140. In an exemplary embodiment, the accessory tray 140 is formed from one piece of material. In some embodiments, the accessory tray 140 is made of a plastic material. The accessory tray 140 is positioned between the billboard 155 and the base 122 and is removably attached to the legs 157 of the frame 114 near the base 122. As such, the accessory tray 140 is in a relatively low position on the pressure washer 110 with the accessories (e.g., spray wand, spray gun, chemical supply containers) positioned further away from the handle 126 than on a conventional pressure washer. Conventional pressure washers include the accessories relatively higher on the pressure washer, creating more opportunities for the accessories to fall off the pressure washer and be damaged. With the accessory tray 140 positioned relatively lower on the pressure washer 110, a user may be less likely to knock out any accessories stored thereon, leading to less opportunities for damage to the accessories.

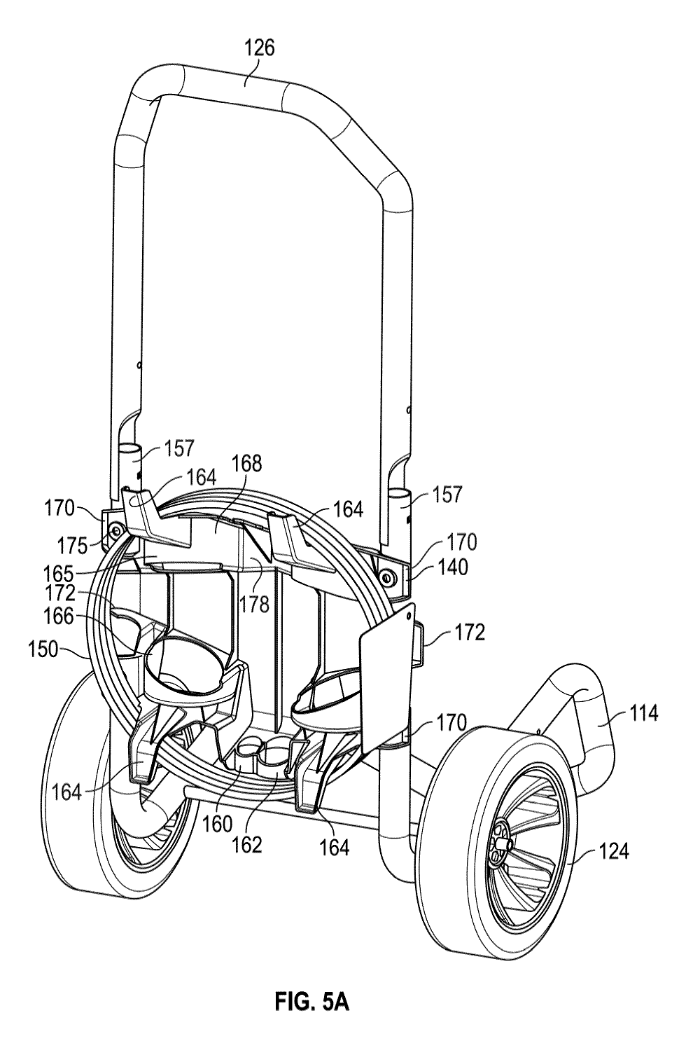

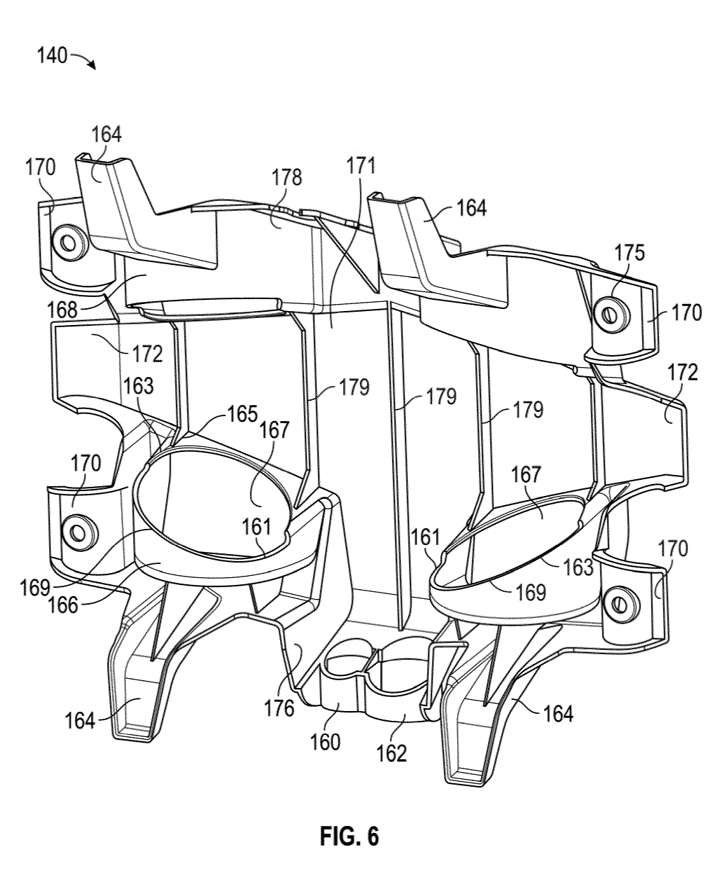

As shown in FIGS. 6-7, the accessory tray 140 includes one or more attachment features 170 configured to removably attach the accessory tray 140 to the pressure washer frame 114. In one embodiment, the attachment feature 170 is curved in shape and is configured to cup (e.g., contact, surround, hold) the shape of the pressure washer frame 114. The curved shape of the attachment feature 170 provides a secure attachment of the accessory tray 140 to the pressure washer frame 114, which has a circular or rounded cross-section. In other embodiments, the attachment feature 170 is any other shape suitable to attach the accessory tray 140 to the pressure washer frame 114. The attachment feature 170 includes one or more apertures 175, each configured to accept a fastener (e.g., screw, bolt) for fastening the accessory tray 140 to the pressure washer frame 114. In some embodiments, the accessory tray 140 further includes one or more attachment support features 172. The attachment support features 172 are configured to cup (e.g., contact, surround, hold) the shape of the pressure washer frame 114. In one embodiment, the attachment support features 172 are curved in shape. The attachment support features 172 restrict the lateral movement of the accessory tray 140 such that if a user accidentally hits the accessory tray 140, the movement of the tray 140 will be limited by contact between the attachment support feature 172 and the frame 114, thereby limiting movement of any accessory stored on the tray 140. In other embodiments, the attachment support features 172 are any other shape suitable to support the attachment of the accessory tray 140 to the pressure washer frame 114.

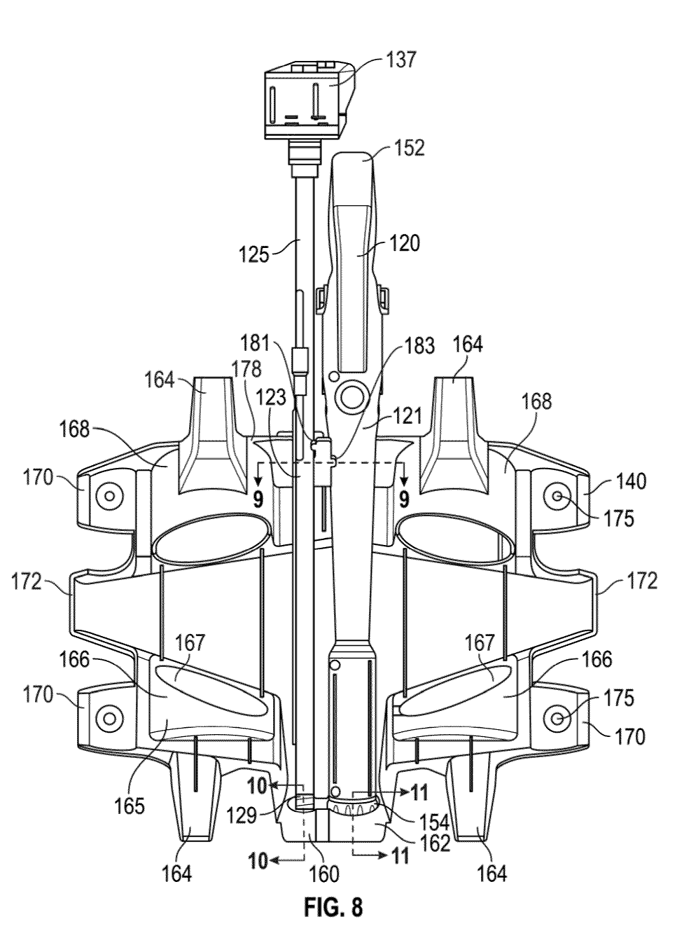

As shown in FIGS. 7-9, the accessory tray 140 includes a spray wand clip 180 and a spray gun clip 182. The spray wand clip 180 is configured to removably attach the spray wand body 123 to the accessory tray 140. The spray wand clip 180 includes one or more protrusions 181 and an inner wall 184. As shown in FIG. 9, the protrusions 181 are configured to hold the spray wand body 123 when in an attached position. In some embodiments, the protrusions 181 are tabs configured to restrict the lateral movement of the spray wand body 123 when attached to the accessory tray 140. The protrusions 181 are sufficiently flexible to allow the spray wand body 123 to pass therethrough and sufficiently resilient such that the spray wand body 123 does not fall out of the clip 180 without a user pulling it past the protrusions 181. In some embodiments, the protrusions 181 are snap features allowing the spray wand body 123 to snap into place on the accessory tray 140. In an attached position, the spray wand body 123 is positioned between the inner wall 184 and the protrusions 181. In some embodiments, the inner wall 184 is a curved shape. In other embodiments, the inner wall 184 is not curved.

The spray gun clip 182 is configured to removably attach the spray gun barrel 121 to the accessory tray 140. The spray gun clip 182 includes one or more protrusions 183 and an inner wall 186. As shown in FIG. 9, the protrusions 183 are configured to hold the spray gun barrel 121 when in an attached position. In some embodiments, the protrusions 183 are tabs configured to restrict the lateral movement of the spray gun barrel 121. The protrusions 183 are sufficiently flexible to allow the spray gun barrel 121 to pass therethrough and sufficiently resilient such that the spray gun barrel 121 does not fall out of the clip 182 without a user pulling it past the protrusions 183. In some embodiments, the protrusions 183 are snap features allowing the spray gun barrel 121 to snap into place on the accessory tray 140. In an attached position, the spray gun barrel 121 is positioned between the inner wall 186 and the protrusions 183. In some embodiments, the inner wall 186 is a curved shape. In other embodiments, the inner wall 186 is not curved.

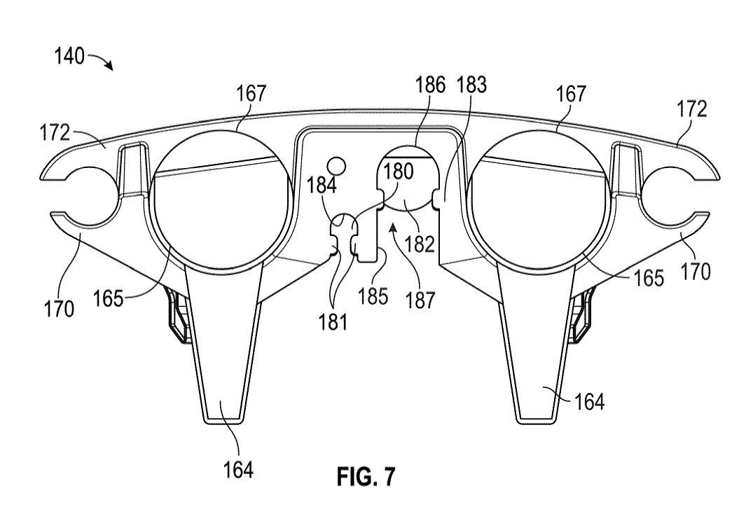

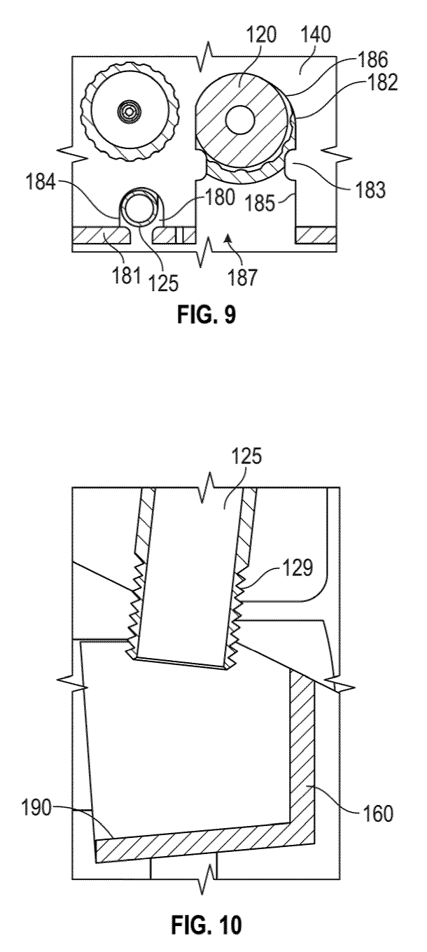

Referring to FIG. 8, the accessory tray 140 further includes a spray wand receptacle 160 and a spray gun receptacle 162. The spray wand receptacle 160 is configured to hold the connector 129 end of the spray wand 125. As shown in FIG. 10, the spray wand receptacle 160 includes a bottom surface 190 and a side wall 191 extending upward from the bottom surface 190 to define a pocket (e.g., tray, receptacle, socket) that receives the connector 129 end of the spray wand 125. The pocket is slightly larger than the connector 129 of the spray wand 125 such that the connector 129 fits within the spray wand receptacle 160. In some embodiments, the spray wand receptacle 160 is configured to catch the spray wand 125 if it moves or falls from the spray wand clip 180. In one embodiment, when the spray wand 125 is in an attached position on the accessory tray 140, the connector 129 contacts spray wand receptacle 160. In another embodiment and as shown in FIG. 10, when the spray wand 125 is in an attached position on the accessory tray 140, the connector 129 does not contact the spray wand receptacle 160 and instead, acts as a back-up if the spray wand 125 detaches and/or falls from the spray wand clip 180. In some embodiments, the bottom surface 190 is omitted. In one embodiment, the spray wand clip 160 is circular shaped. In another embodiment, the spray wand receptacle 160 is rectangular shaped. In other embodiments, the spray wand receptacle 160 is any shape suitable to receive the connector 129 end of the spray wand 125.

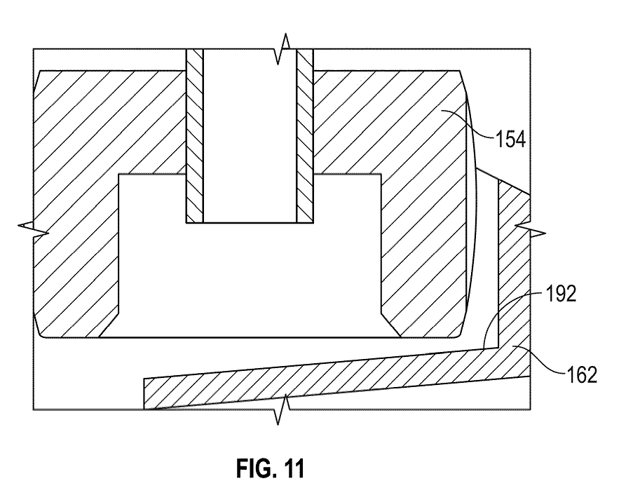

The spray gun receptacle 162 is configured to hold the nozzle 154 end of the spray gun 120. As shown in FIG. 11, the spray gun receptacle 162 includes a bottom surface 192 and a side wall 193 extending upward from the bottom surface 192 to define a pocket (e.g., tray, receptacle, socket) that receives the nozzle 154 end of the spray gun 120. The pocket is slightly larger than the nozzle 154 such that the nozzle 154 fits within the spray wand receptacle 160. In some embodiments, the spray gun receptacle 162 is configured to catch the spray gun 120 if it moves or falls from the spray gun clip 182. In one embodiment, when the spray gun 120 is in an attached position on the accessory tray 140, the nozzle 154 contacts the bottom surface 192 of the spray gun receptacle 162. In another embodiment and as shown in FIG. 11, when the spray wand 125 is in an attached position on the accessory tray 140, the nozzle 154 does not contact the bottom surface 192 of the spray gun receptacle 162 and instead, acts as a back-up if the spray gun 120 detaches and/or falls from the spray gun clip 182. In some embodiments, the bottom surface 192 is omitted. In one embodiment, the spray gun receptacle 162 is circular shaped. In another embodiment, the spray gun receptacle 162 is rectangular shaped. In other embodiments, the spray gun receptacle 162 is any shape suitable to receive the nozzle 154 end of the spray gun 120.

To releasably attach the spray gun 120 to the accessory tray 140, the user can insert the nozzle 154 of the spray gun 120 into the spray gun receptacle 162 and then push the barrel 121 through channel 187 and past the protrusions 183 to position the barrel 121 between the protrusions 183 and the inner wall 186 of the spray gun clip 182. To releasably attach the spray wand 125 to the accessory tray 140, the user can insert the connector 129 of the spray wand 125 into the spray wand receptacle 160 and then push the spray wand body 123 past the protrusions 181 to position the body 123 between the protrusions 181 and the inner wall 184 of the spray wand clip 180.

The accessory tray 140 further includes a chemical container holder 165 configured to hold a chemical supply container 135. The chemical container holder 165 includes a top portion 168 and a bottom portion 166. The top portion 168 and the bottom portion 166 define an inner wall 167 into which a chemical supply container 135 can be inserted. In one embodiment, the inner wall 167 is a cylindrical shape. In another embodiment, the top portion 168 and the bottom portion 166 define any other suitable shape into which the chemical supply container 135 can be inserted. The bottom portion 166 includes a bottom surface which the chemical supply container 135 contacts to support the chemical supply container 135 when in an inserted position. In an alternative embodiment, the bottom portion 166 does not include a bottom surface which the chemical supply container 135 contacts. In this embodiment, the chemical supply container 135 is held in the bottom portion 166 by the inner wall 167 of the bottom portion 166. In this case, the inner wall 167 of the bottom portion 166 may taper inward toward the bottom. To insert the chemical supply container 135 into the chemical container holder 165, a user slides the chemical supply container 135 inside the top portion 168 and through the bottom portion 166 to rest within the bottom portion 166 of the chemical container holder 165.

As shown in FIG. 6, the bottom portion 166 of the chemical container holder 165 is angled relative to vertical. The bottom portion 166 includes a perimeter 169 including a low side 161 and a high side 163. In an exemplary embodiment, the perimeter 169 is circular in shape. In other embodiments, the perimeter 169 can be any suitable shape to receive the chemical supply container 135. As shown in FIG. 6, the high side 163 and low side 161 are positioned opposite from one another on the perimeter 169 of the bottom portion 166. The high side 163 is positioned nearer the attachment features 170 and the low side 161 is positioned nearer the spray wand receptacle 160 and the spray gun receptacle 162. In alternative embodiments, the high side 163 and low side 161 can be positioned in any configuration on the bottom portion 166. The high side 163 limits the movement of the chemical supply container 135. The difference in height between the low side 161 and the high side 163 can make insertion and removal of the chemical supply container 135 easier by reducing the surface area of the inner wall 167 with which the chemical supply container 135 is contacting, while still maintaining the support of the high side 163 that is comparable to a chemical container holder 165 with uniform height.

The accessory tray 140 includes one or more hooks 164 formed on the chemical container holder 165. As shown in FIG. 5A, the hooks 164 are configured to hold a hose 150 in a wrapped configuration. In an exemplary embodiment, the accessory tray 140 includes four hooks 164 with two hooks on the top portion 168 of the chemical container holder 165 and two hooks on the bottom portion 166 of the chemical container holder 165. In some embodiments, the accessory tray 140 includes two hooks 164 with one hook on each the bottom portion 166 and the top portion 168. In other embodiments, there can be any number of hooks 164 suitable to hold the hose 150. The hooks 164 on the top portion 168 extend outward from the chemical container holder 165 in an upward direction and the hooks 164 on the bottom portion 166 extend outward from the chemical container holder 165 in a downward direction.

The accessory tray 140 provides various advantages to a user. The spray wand 125 and spray gun 120 are both attached at two points on the accessory tray 140, one attachment point at one end of each of the spray wand 125 and spray gun 120 and another attachment point near the end of each. Thus, there is only one free end of the gun 120 and wand 125, with that end positioned near an attachment point, providing for more stability. This is particularly beneficial when a user is transporting and/or moving the pressure washer 110. It is less likely that a user may accidentally hit the spray gun 120 or wand 125 out of their respective holders. Additionally, the position of the accessory tray 140 near the base 122 lowers the center of gravity of the pressure washer 110 providing for further stability.

As utilized herein, the terms “approximately,” “about,” “proximate,” “substantially,” and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “exemplary” as used herein to describe various embodiments is intended to indicate that such embodiments are possible examples, representations, and/or illustrations of possible embodiments.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the accompanying drawings. The orientation of various elements may differ according to other exemplary embodiments, and that such variations are intended to be encompassed by the present disclosure.

The construction and arrangement of the pressure washer as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer, comprising:
a mounting platform;
a prime mover supported by the mounting platform;
a pump driven by the prime mover;
a frame configured to support the mounting platform;
a handle extending upward from the mounting platform;
a spray gun including a barrel, a handle, and a nozzle; and
an accessory tray attached to the frame proximate the mounting platform, the accessory tray comprising:
a spray gun clip configured to hold the barrel; and
a spray gun receptacle configured to hold the nozzle.

2. The pressure washer of claim 1, further comprising a spray wand including a connector, a wand nozzle, and a conduit extending between the connector and the wand nozzle, wherein the spray wand is configured to connect to the spray gun at the connector.

3. The pressure washer of claim 2, wherein the accessory tray further comprises a spray wand clip configured to hold the spray wand at the conduit.

4. The pressure washer of claim 3, wherein the accessory tray further comprises a protrusion on the spray wand clip configured to limit movement of the spray wand.

5. The pressure washer of claim 4, wherein the accessory tray further comprises a spray wand receptacle configured hold the connector.

6. The pressure washer of claim 5, further comprising a chemical supply container.

7. The pressure washer of claim 6, wherein the accessory tray further comprises a chemical container holder configured to hold the chemical supply container.

8. The pressure washer of claim 7, wherein the accessory tray further comprises a hose holder, wherein the hose holder is formed on the chemical container holder.

9. The pressure washer of claim 8, further comprising a hose, wherein when stored on the pressure washer, the hose contacts the hose holder.

10. The pressure washer of claim 9, wherein the accessory tray further comprises an attachment and a support attachment;
wherein the attachment is configured to attach the accessory tray to the frame; and
wherein the support attachment contacts the frame on an opposite side from the attachment.

11. The pressure washer of claim 10, wherein the spray gun is configured to attach to the chemical supply container via a chemical supply conduit.

12. The pressure washer of claim 1, further comprising a chemical supply container.

13. The pressure washer of claim 12, wherein the accessory tray further comprises a chemical container holder configured to hold the chemical supply container.

14. The pressure washer of claim 13, wherein the accessory tray further comprises a hose holder, wherein the hose holder is formed on the chemical container holder.

15. The pressure washer of claim 14, further comprising a hose, wherein when stored on the pressure washer, the hose contacts the hose holder.

16. The pressure washer of claim 15, wherein the accessory tray further comprises an attachment and a support attachment;
wherein the attachment is configured to attach the accessory tray to the frame; and
wherein the support attachment is configured to contact the frame on an opposite side from the attachment.

17. An accessory tray configured for use with a pressure washer, comprising:
a spray gun clip configured to hold a spray gun at a barrel of the spray gun;
a spray gun receptacle configured to accept the spray gun at a connector of the spray gun;
a spray wand clip configured to hold a spray wand at a conduit of the spray wand;
a spray wand receptacle configured to hold the spray wand at a wand nozzle; and
a chemical container holder configured to hold a chemical supply container, wherein the chemical container holder includes a top portion and a bottom portion.

18. The accessory tray of claim 17, further comprising a first hook configured to hold a hose, wherein the first hook is formed on the top portion of the chemical container holder.

19. The accessory tray of claim 18, further comprising a second hook configured to hold the hose, wherein the second hook is formed on the bottom portion.

20. The accessory tray of claim 19, further comprising an attachment and a support attachment;
wherein the attachment attaches to a frame of the pressure washer;
wherein the attachment comprises an aperture configured to receive a fastener to couple the accessory tray to the frame; and
wherein the support attachment is configured to contact the frame on an opposite side from the attachment.
